(19) United States
(12) Patent Application Publication
(10) Pub. No.: US 2009/0262739 A1
(43) Pub. Date: Oct. 22, 2009

(54) NETWORK DEVICE OF PROCESSING PACKETS EFFICIENTLY AND METHOD THEREOF

(76) Inventor: Kuo-Cheng Lu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/272,761

(22) Filed: Nov. 17, 2008

(30) Foreign Application Priority Data
Apr. 21, 2008 (TW) 097114476

(51) Int. Cl. H04L 12/56

(52) U.S. Cl. 370/392

(57) ABSTRACT

A network device includes a first memory, a second memory, a receiver, a CPU, a transmitter, and a header cache controller (HCC). The HCC is coupled to the first memory and the second memory. The receiver, the CPU, and the transmitter access the first memory and the second memory via the HCC. The HCC can map an address of the first memory storing a header of a packet to an address of the second memory so as to store the header of the packet in the second memory.

### BACKGROUND OF THE INVENTION

1. Field of the Invention

The present invention relates to a network device, and more particularly, to a network device of processing packets efficiently.

2. Description of the Prior Art

In modern network devices, caches have been widely used to improve overall efficiency of a system. However, using caches possibly generates two kinds of problems: one is data consistency, and the other is cache pollution derived from processing packets. Many high-level embedded systems comprise caches, though most of them do not guarantee data consistency. Therefore, when a network device uses a cache to process packets, the central processing unit (CPU) has to be careful of data consistency. Additionally, cache pollution describes a situation that data is stored in the cache without being used for longer than a certain period of time. However, due to the characteristic of the packets, the cache pollution does exist when the cache is used for processing packets.

Please refer to FIG. 1. FIG. 1 is a diagram illustrating data inconsistency when a conventional network device 10 uses a cache to process data. A direct memory access (DMA) device 18 receives a packet from the network and stores the packet in an external memory 16 assigned by the CPU 12. After the packet is completely received, the DMA device 18 sends an interrupt request to the CPU 12 for processing the received packet. According to the used cache protocols (i.e. write through or write back), the CPU 12 copies the packet as a temporary file for quick reference in the cache 14. However, after the CPU 12 accesses the temporary file of the packet, the data consistency rises between the cache 14 and the external memory 16. For example, after the CPU 12 reads the data of the packet, the CPU has to invalidate the cache for avoiding reading old data stored in the cache 14. When the CPU 12 informs the DMA device 18 for transmitting the modified packets, the CPU 12 has to flush the cache 14. In this way, the stored packets in the cache 14 can be copied to the external memory 16. Consequently, the cache pollution rises when the cache 14 is used for processing packets, and furthermore, the efficiency of the cache is deteriorated.

Please refer to FIG. 2. FIG. 2 is a diagram illustrating when a conventional network device 20 uses snooping device for processing data of the cache. The snooping device 32 checks for data consistency between the cache 14 of the CPU 12 and the external memory 16. When the CPU 12 executes programs or processes data, it is possibly that the required data is loaded from the external memory 16 onto the cache 14 for speeding up the access of the required data. However, after the CPU 12 updates the data stored in the cache 14, the corresponding data stored in the external memory 16 is not updated immediately. Meanwhile, if the DMA device 18 accesses the data stored in the external memory 16, the DMA device 18 may possibly accesses the non-updated data, which is incorrect. Thus, when the DMA device 18 accesses the data stored in the external memory 16, the snooping device 32 checks if the data stored in the cache 14 of the CPU 12 belongs to the data that the DMA device 18 accesses for ensuring correction of the data that the DMA device 18 accesses. However, the speed of the snooping device 32 is limited by the core speed of the CPU 12, which complicates the design in realization.

Please refer to FIG. 3. FIG. 3 is a diagram illustrating when a conventional network device 30 uses a scratch pad memory for processing packets. A packet can be divided into two parts: header, and payload. Generally, the header of a packet is far more frequently accessed than the payload of the packet. Therefore, the DMA interface of a receiver 26 respectively receives the header of a packet and the payload of the packet, and stores the header of the packet in the scratch pad memory 24 (i.e. synchronous random access memory, SRAM), and stores the payload of the packet in the external memory 16 (i.e. dynamic random access memory, DRAM). In this way, when the CPU 12 accesses the header of the packet from the scratch pad memory 24, the access time is shorter since the scratch pad memory 24 has higher access speed. After the packet process is completed by the CPU 12, the DMA interface of a transmitter 28 reads the header of the processed packet from the scratch pad memory 24 and the payload of the processed packet from the external memory 16 for transmitting the processed packet. Though the data consistency and the cache pollution are solved by using the scratch pad memory 24, however, in this prior art, the DMA interfaces of the receiver 26 and the transmitter 28 have to support the operation for respectively transmitting the header of the packet and the payload of the packet. Besides, for the CPU 12, the packet is divided and stored in non-continuous memory space. If the CPU 12 is the destination of the packet, the CPU 12 still has to copy the packet and stores the copied packet in a continuous memory space for processing.

### SUMMARY OF THE INVENTION

The present invention provides a network device. The network device comprises a first memory, a receiver for receiving a packet from a network and storing the packet in the first memory, a CPU for processing the packet, a transmitter for transmitting the packet to the network, a second memory for storing a header of the packet, and a HCC coupled to the first memory and the second memory. The receiver, CPU, and transmitter access the first memory and the second memory through the HCC. The HCC maps an address of the first memory storing the header of the packet to a corresponding address of the second memory so as to store the header of the packet in the second memory.

The present invention further provides a method of a network device processing packets. The method comprises a receiver receiving a packet from a network, a CPU providing a descriptor to the receiver and storing the packet to a first memory, determining data of a predetermined length that the receiver writes after reading the descriptor as a header of the packet, and mapping an address of the first memory storing the header of the packet to a corresponding address of second memory so as to store the header of the packet in the second memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating data inconsistency when a conventional network device uses a cache to process data.

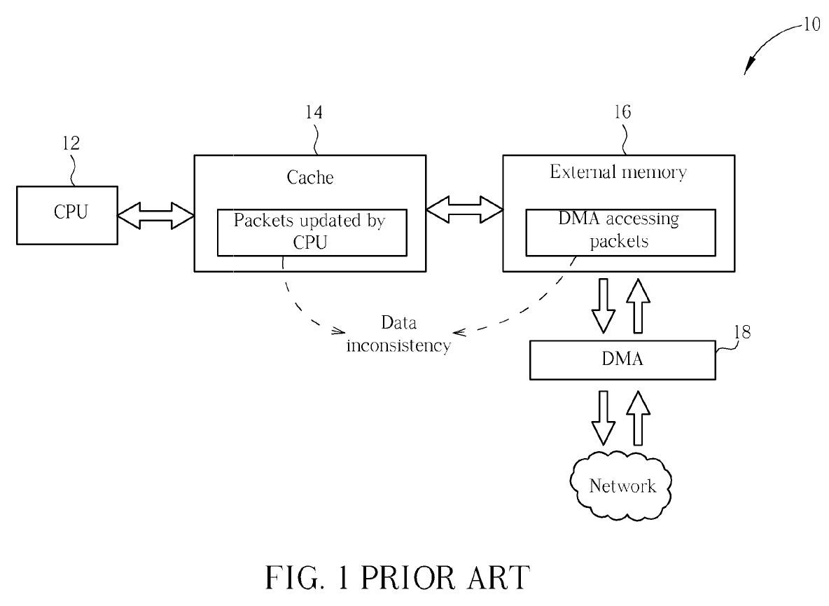

FIG. 2 is a diagram illustrating when a conventional network device uses a snooping device for processing data of the cache.

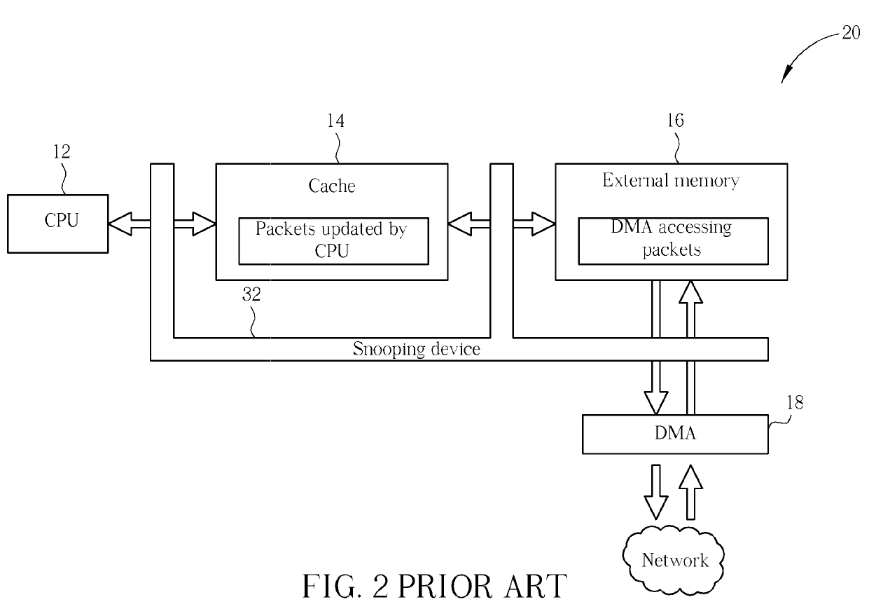

FIG. 3 is a diagram illustrating when a conventional network device uses a scratch pad memory for processing packets.

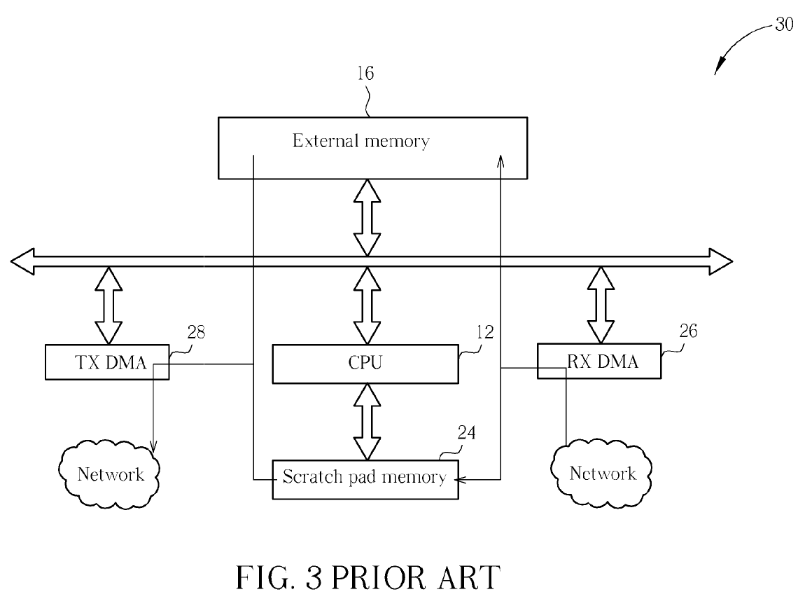

FIG. 4 is a diagram illustrating when a network device of the present invention uses HCC to process data.

FIG. 5 is a diagram illustrating the paths of the network device of the present invention processing the packets.

FIG. 6 is a diagram illustrating a lookup table that HCC uses for mapping between the first memory and the second memory.

### DETAILED DESCRIPTION

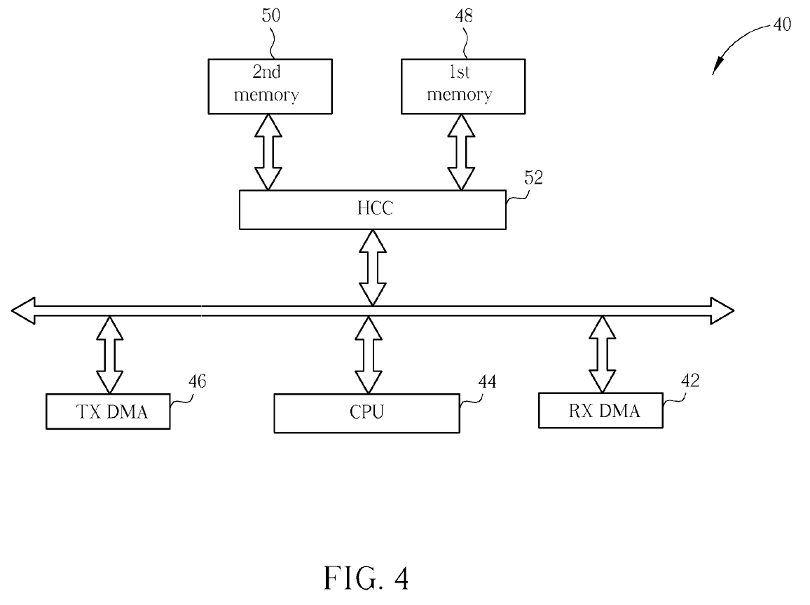

Please refer to FIG. 4. FIG. 4 is a diagram illustrating an embodiment when a network device 40 of the present invention uses header cache controller (HCC) to process data. The network device 40 comprises a receiver 42, a CPU 44, a transmitter 46, a first memory 48, a second memory 50, and a HCC 52. In this embodiment, the first memory 48 can be realized with an external memory having big memory space (usually be DRAM), and the second memory 50 can be realized with a high-speed memory (usually be SRAM). The access time of the second memory 50 is shorter than the access time of the first memory 48. The HCC 52 is coupled to the first and the second memories 48 and 50. The receiver 42, the CPU 44, and the transmitter 46, access the first and the second memories 48 and 50 through the HCC 52. The HCC 52 maps an address of the first memory 48 to a corresponding address of the second memory 50 according to a lookup table. For example, a first address of the first memory 48 is mapped to a second address of the second memory 50 in the lookup table, and thus in this way, when the receiver 42, the CPU 44, and the transmitter 46 access the first address of the first memory 48, the receiver 42, the CPU, and the transmitter 46 access the data stored at the second address in the second memory 50 instead of the data stored at the first address in the first memory 48. Since the header of a packet is far more frequently accessed than the payload of the packet, the HCC 52 utilizes the method described above, which maps an address of the header of a packet stored in the first memory 48 to a corresponding address of the second memory 50 according to the lookup table for actually storing the header of the packet at the corresponding address in the second memory 50 instead of storing the header of the packet at the address in the first memory 48. Consequently, the efficiency of the network device 40 is increased.

The HCC 52 of the present invention determines the header and the payload of an accessed packet according to the characteristics of the accessed packet. When the receiver 42 receives a packet from the network, the CPU 44 provides a descriptor to the receiver 42 for storing the received packet in the first memory 48. After the receiver 42 reads the descriptor for the received packet, the header of the received packet starts to be written. Thus, the HCC 52 defines data of a predetermined length starting to be written after the receiver 42 reads the descriptor corresponding to the received packet as the header of the received packet. In this way, when the receiver 42 stores the header of the received packet at an address in the first memory 48, the HCC 52 finds a corresponding space at a corresponding address in the memory 50 for storing the header of the received packet, and records the mapping between the address in the first memory 48 and the corresponding address in the second memory 50, in the lookup table. In this way, the header of received packet is actually stored at the corresponding address in the second memory 50 instead of being stored at the address in the first memory 48. Besides, if there is no corresponding space in the second memory 50 for storing the header of the received packet, the HCC 52 does not execute the action described above, and the header of the received packet is still stored at the original address in the first memory 48. Furthermore, after the header of the received packet is read from the second memory 50, the mapping between the address of the first memory 48 and the corresponding address of the second memory 50 recorded in the lookup table is invalidated.

According to the present embodiment, when the DMA interface (RX DMA) of the receiver 42 starts to write the header of a received packet, the HCC 52 controls the header of the received packet to be written to the second memory 50. After the packet is completely received, if the CPU 44 accesses the header of the received packet, the HCC 52 leads the CPU 44 to the second memory 50. After the CPU 44 completes the processing of the received packet, the CPU 44 informs the transmitter 46 to transmit the processed packet. When the DMA interface (TX DMA) of the transmitter 46 starts to read the processed packet, the HCC 52 checks the address that the transmitter 46 reads according to the lookup table. If the address that the transmitter 46 reads, according to the lookup table, represents where the header of the processed packet is stored, the HCC 52 leads the DMA interface of the transmitter 46 to the second memory 50. After the header of the processed packet is completely read from the second memory 50, the HCC 52 invalidates the mapping between the address of the first memory 48 (represents where the header of the processed packet is assumed to be stored) and the corresponding address of the second memory 50 (represents where the header of the processed packet is actually stored) recorded in the lookup table.

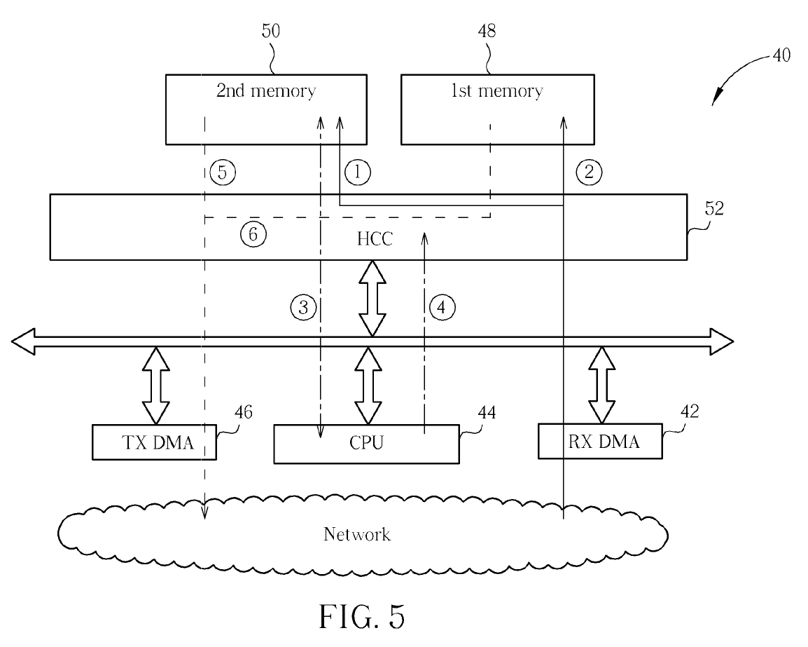

Please refer to FIG. 5. FIG. 5 is a diagram illustrating the paths of the network device 40 of the present invention processing the packets. There are three kinds of transmitting manners in a network system: 1. the packet is transmitted from the network to a destination, 2. the packet is transmitted from the network to a destination, and then transmitted again from the destination to the network, and 3. the packet is transmitted from a destination to the network. Therefore, the paths of the network device 40 of the present invention processing the packets comprise the following six paths:

Path 1: When the DMA interface of the receiver 42 starts to write the header of a received packet, the HCC 52 assigns the header of the received packet to be written to the second memory 50.

Path 2: When the DMA interface of the receiver 42 starts to write the payload of a received packet, the HCC 52 assigns the payload of the received packet to be written to the first memory 48.

Path 3: When the CPU 44 accesses the header of the packet, the HCC 52 leads the CPU 44 to the second memory 50.

Path 4: When the transfer of the packet is terminated in the CPU 44, the CPU 44 sends a command to the HCC 52 for invalidating the header mapping between the addresses at the first memory 48 and the second memory 50 in the lookup table.

Path 5: When the DMA interface of the transmitter 46 reads the header of the received packet, the HCC 52 leads the DMA interface of the transmitter 50 to the second memory 50.

Path 6: When the DMA interface of the transmitter 46 starts to read the payload of the received packet, the HCC 52 leads the DMA interface of the transmitter 46 to the first memory 48.

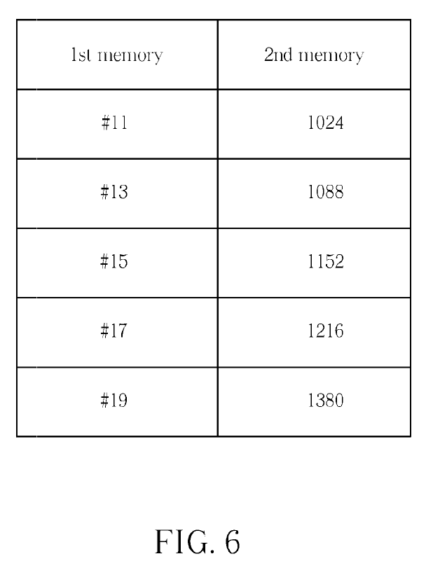

Please refer to FIG. 6. FIG. 6 is a diagram illustrating a lookup table that HCC uses for mapping between the first memory and the second memory. In the present embodiment, the first memory 48 can be an external memory having big memory space (i.e. DRAM), and the second memory 50 can be a high-speed memory (i.e. SRAM). The HCC 52 utilizes the lookup table as shown in FIG. 6 for mapping a corresponding address in the second memory 50 to an address in the first memory 48. For example, the address 1024 of the second memory 50 is mapped to the address #11 of the first memory 48. In this way, when the CPU 44 or DMA interface access the data at the address #11 in the first memory 48, in fact the data stored at the address 1024 in the second memory 50 is accessed. Therefore, when the CPU 44 processes the headers of packets, the actual memory being used is the high-speed second memory 50, which increases the processing efficiency. However, from the aspect of the CPU 44 or the DMA interface, it seems that the header and the payload of a packet are stored in a continuous memory space in the first memory 48, which implies that the CPU 44 does not have to execute synchronization between memories, and the receiver 42 and the transmitter 46 also do not have to be modified because of respectively transmitting the header and the payload of a packet.

To sum up, the network device of the present invention utilizes high-speed memory for processing headers of packets for increasing efficiency. The network device of the present invention comprises a first memory, a second memory, a receiver, a CPU, a transmitter, and a HCC. The HCC is coupled to the first and the second memories, and the receiver, the CPU, and the transmitter access the first and the second memories through the HCC. The HCC is utilized for mapping an address for storing the header of a packet in the first memory to a corresponding address in the second memory, and thus the header of the packet in fact is stored at the corresponding address in the second memory. Besides, the HCC utilizes the characteristic of a packet to find out the header of the packet. That is, after the receiver receives a packet from the network, the CPU provides a descriptor to the receiver, in order to store the packet in the first memory, and the HCC defines data of a predetermined length that the receiver writes after reading a descriptor as the header of the packet. Next, the HCC maps the address in the first memory where the header of the packet is assumed to be stored to a corresponding address of the second memory for actually storing the header of the packet at the corresponding address in the second memory. Since the second memory has higher access speed, the efficiency of the network device is increased.

Those skilled in the art will readily observe that numerous modifications and alterations of the device and method may be made while retaining the teachings of the invention.

What is claimed is:

1. A network device, comprising:
a first memory;
a receiver for receiving a packet from a network and storing the packet in the first memory;
a central processing unit (CPU) for processing the packet;
a transmitter for transmitting the packet to the network;
a second memory for storing a header of the packet; and
a header cache controller (HCC) coupled to the first memory and the second memory, the receiver, the CPU, and the transmitter to access the first memory and the second memory through the HCC, the HCC mapping an address of the first memory storing the header of the packet to a corresponding address of the second memory so as to store the header of the packet in the second memory.

2. The network device of claim 1, wherein the HCC stores the address of the first memory and the corresponding address of the second memory in a lookup table.

3. The network device of claim 1, wherein the HCC determines data of a predetermined length written by the receiver after reading a descriptor as the header of the packet.

4. The network device of claim 1, wherein the HCC invalidates the corresponding address of the second memory mapping to the address of the first memory after the transmitter reads the header of the packet.

5. The network device of claim 1, wherein the first memory is a dynamic random access memory (DRAM) and the second memory is a synchronous random access memory (SRAM).

6. The network device of claim 1, wherein the access time of the second memory is shorter than the first memory.

7. The network device of claim 1, wherein a payload of the packet is stored in the first memory.

8. A method of processing packets by a network device, comprising:
a receiver receiving a packet from a network;
a central processing unit (CPU) providing a descriptor to the receiver and storing the packet to a first memory;
determining data of a predetermined length written by the receiver after reading the descriptor as a header of the packet; and
mapping an address of the first memory storing the header of the packet to a corresponding address of second memory so as to store the header of the packet in the second memory.

9. The method of claim 8, further comprising:
storing the address of the first memory and the corresponding address of the second memory in a lookup table.

10. The method of claim 8, further comprising:
invalidating the corresponding address of the second memory mapping to the address of the first memory after the transmitter reading the header of the packet.

11. The method of claim 8, further comprising:
the CPU sending a command to invalidate the corresponding address of the second memory mapping to the address of the first memory.

12. The method of claim 8, further comprising:
storing a payload of the packet in the first memory.
